(19) United States
(12) Patent Application Publication
(10) Pub. No.: US 2013/0057857 A1
(43) Pub. Date: Mar. 7, 2013

(54) IMPEDANCE MATCHING GROUND PLANE FOR HIGH EFFICIENCY COUPLING WITH OPTICAL ANTENNAS

(71) Applicant: THE REGENTS OF THE UNIVERSITY OF CALIF, Oakland, CA (US)

(72) Inventors: Arash Jamshidi, Berkeley, CA (US); Tae Joon Seok, Berkeley, CA (US); Myungki Kim, Albany, CA (US); Amit Lakhani, Emeryville, CA (US); Ming C. Wu, Moraga, CA (US)

(73) Assignee: THE REGENTS OF THE UNIVERSITY OF CALIFORNIA, Oakland, CA (US)

(21) Appl. No.: 13/657,535

(22) Filed: Oct. 22, 2012

Related U.S. Application Data
(63) Continuation of application No. PCT/US2011/034219, filed on Apr. 27, 2011.
(60) Provisional application No. 61/329,059, filed on Apr. 28, 2010.

(51) Int. Cl. G01J 3/44; H01P 11/00

(52) U.S. Cl. 356/301; 29/600

(57) ABSTRACT

An optical nanoantenna ground plane apparatus and method which enhances electric field intensity, surface-enhanced Raman spectroscopy (scattering). A dielectric spacer layer is disposed between a nanoantenna layer and a metallic ground plane layer. Thickness of the dielectric spacer layer is determined in response to matching metal loss resistance and radiation resistance of the optical nanoantenna layer for a given optical antenna configuration and operating wavelength, such as in response to finite difference time domain (FDTD) simulations which determine dielectric spacer layer thickness when radiation quality factor and absorption quality factor are equal. The inventive ground plane can be implemented for a wide range of optical applications regardless of whether fabrication of the nanoantenna-groundplane combination is fabricated in a top-down or bottom-up sequence.

### CROSS-REFERENCE TO RELATED APPLICATIONS

This application a 35 U.S.C. §111(a) continuation of PCT international application number PCT/US2011/034219 filed on Apr. 27, 2011, incorporated herein by reference in its entirety, which is a nonprovisional of U.S. provisional patent application Ser. No. 61/329,059 filed on Apr. 28, 2010, incorporated herein by reference in its entirety.

The above-referenced PCT international application was published as PCT International Publication No. WO 2012/011998 on Jan. 26, 2012 and republished on Apr. 26, 2012, and is incorporated herein by reference in its entirety.

### STATEMENT REGARDING FEDERALLY SPONSORED RESEARCH OR DEVELOPMENT

This invention was made with Government support under Grant No. FA9550-08-1-0257 awarded by DARPA SERS S&T Fundamentals. The Government has certain rights in the invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to antennas, and more particularly to ground planes for optical antennas.

2. Description of Related Art

Optical radiation is typically manipulated by redirecting its wavefronts with lenses and mirrors, which are subject to diffraction. As a consequence of this diffraction, optical fields cannot be localized to dimensions which are much less than the optical wavelength.

Optical antennas (nanoantennas) provide a solution as they can efficiently couple the energy of free-space radiation to a confined region of subwavelength size. Although the use of radio-frequency (RF) antennas is widespread, such as in the radiowave and microwave regimes, they are an emerging technology at optical frequencies.

The concept of optical antennas has been extensively used to enhance the Raman signal detected from molecules through a process known as surface enhanced Raman spectroscopy (SERS). The optical antennas achieve this enhancement by local sub-diffraction limited focusing of the electric field intensity. However, it is difficult to achieve efficient coupling of optical antennas.

Therefore, a need exists for optical antenna structures which can be efficiently coupled to optical elements. The present invention fulfills that need and others, and overcomes drawbacks of previous technologies.

### BRIEF SUMMARY OF THE INVENTION

An apparatus and method are described for a metallic ground plane for increasing coupling efficiency for optical nanoantennas. The ground plane can be utilized in various optical applications, including use in combination with bottom-up chemically synthesized nanoantennas (metallic nanoparticles) and top-down fabricated antenna structures.

The term optical antenna and optical nanoantenna will be utilized interchangeable herein, as the optical wavelengths are in the nanometer range, wherein any optical antenna is by nature an optical nanoantenna according to this definition.

Optical antennas, in particular optical nanoantennas, are being extensively utilized to enhance the Raman signal detected from molecules through a process known as surface enhanced Raman spectroscopy (SERS), also referred to as surface-enhanced Raman scattering. The optical antennas achieve this enhancement through local sub-diffraction limited focusing of the electric field intensity. Typical optical antennas comprise nanoantennas (e.g., gold (Au) nano particles) arranged on a quartz glass substrate.

It has been found in developing the present invention, however, that the detected SERS signals can be enhanced by more than an order of magnitude through increasing coupling efficiency in response to combining a metallic ground plane of a particular structure with the optical antennas. Utilizing the inventive ground plane, the power transmitted to the antennas is maximized when the radiation resistance of the antenna matches the Ohmic resistance (metal absorption).

Impedance matching utilizing the inventive ground plane is arrived at by tuning the thickness of a dielectric spacer disposed between the optical antennas and a metallic ground plane. The thickness of the spacer layer is an important parameter that can be optimized to achieve maximum field enhancement. The inventive optical ground plane can also be utilized for enhancing signals from other emission mechanisms, such as fluorescence or photoluminescence.

The invention is amenable to being embodied in a number of ways, including but not limited to the following descriptions.

One embodiment of the invention is an optical antenna ground plane apparatus, comprising: (a) a metallic layer disposed as a ground plane proximal to an optical nanoantenna layer; and (b) a dielectric spacer layer of a selected thickness disposed between the metallic layer and the optical nanoantenna layer; (c) wherein the thickness of the dielectric spacer layer is determined in response to matching metal loss resistance and radiation resistance of the optical nanoantenna layer for a given optical antenna configuration and operating wavelength.

At least one embodiment of the invention is configured for using a dielectric spacer of any desired insulating material compatible with the optical nanoantenna and ground plane, such as comprising silicon-dioxide (SiO₂).

At least one embodiment of the invention is configured for using a metallic layer of any desired metal or metal composition, such as comprising gold (Au).

At least one embodiment of the invention is configured for determining the thickness of the dielectric layer in response to matching the metal loss resistance and radiation resistance of the optical nanoantenna layer for a given optical antenna configuration and operating wavelength.

At least one embodiment of the invention is configured for matching the metal loss resistance and radiation resistance of the optical nanoantenna layer in response to performing finite difference time domain (FDTD) simulations.

One embodiment of the invention is an optical antenna ground plane apparatus, comprising: (a) a metallic layer disposed as a ground plane proximal to an optical nanoantenna layer; and (b) a dielectric spacer layer of a selected thickness disposed between the metallic layer and the optical nanoantenna layer; (c) wherein the thickness of the dielectric spacer layer is determined in response to matching metal loss resistance and radiation resistance of the optical nanoantenna layer for a given optical antenna configuration and operating wavelength, which is determined in response to determining a dielectric thickness at which radiation quality factor and absorption quality factor are equal.

One embodiment of the invention is a method of fabricating an optical nanoantenna ground plane, comprising: (a) determining a dielectric spacer layer thickness value at which metal loss resistance and radiation resistance are equal for an associated optical nanoantenna layer; (b) fabricating a ground plane having a dielectric layer, of the dielectric space layer thickness, disposed adjacent a nanoantenna layer, and a metallic ground plane layer.

The present invention provides a number of beneficial elements which can be implemented either separately or in any desired combination without departing from the present teachings.

An aspect of the invention is an optical ground plane structure which improves impedance matching of optical antennas.

Another aspect of the invention is an optical ground plane structure which maximizes power transfer to the antenna in response to matching the metal resistance to the radiation resistance of the antenna.

Another aspect of the invention is an optical ground plane structure which is configured to significantly enhance optical field intensity, such as by a factor of five, which is a multiple times increase in the optical field intensity.

Another aspect of the invention is an optical ground plane structure whose surface-enhanced Raman spectroscopy (SERS), signal is enhanced by approximately a factor of thirty, which is more than an order of magnitude.

Another aspect of the invention is an optical ground plane structure having a dielectric layer between the optical antenna and a ground plane whose thickness is determined in response to determining time domain differences, such as in response to finite difference time domain (FDTD) simulations.

A still further aspect of the invention is an optical ground plane structure which can be utilized in a wide range of optical applications.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a cross section view of a ground plane of an optical antenna according to an embodiment of the present invention.

FIG. 2 is a schematic of a circuit analogy for impedance matching within an optical antenna ground plane shown in FIG. 1.

FIG. 3 is a graph of finite difference time domain (FDTD) simulations, showing quality factor, according to an element of the present invention.

FIG. 4 is a graph of finite difference time domain (FDTD) simulations, showing electric field enhancement (E²), according to an element of the present invention.

FIG. 5 is a graph of electric field enhancement (E²) with respect to wavelength according to an element of the present invention.

FIG. 6 is a graph of surface enhanced Raman spectroscopy (SERS) according to an element of the present invention.

### DETAILED DESCRIPTION OF THE INVENTION

Optical antennas have been extensively utilized for enhancing Raman signal detection from molecules through a process known as surface enhanced Raman spectroscopy (SERS). This enhancement is achieved in optical antennas by local sub-diffraction limited focusing of the electric field intensity. The inventive teachings herein describe structure, fabrication, and testing of an inventive metallic ground plane which provides efficient coupling of optical antennas for a given antenna geometry and operating wavelength, or wavelength range, which further enhances the SERS signal by more than an order of magnitude.

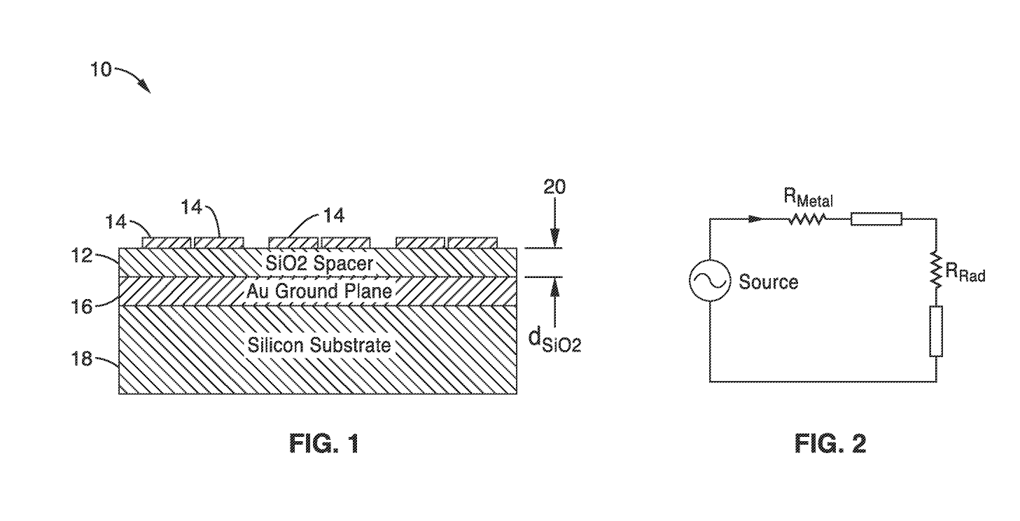

FIG. 1 illustrates an example embodiment 10 of a ground plane which facilitates high efficiency coupling of optical antennas for a given wavelength range. The inventive ground plane comprises a dielectric spacer layer (e.g., SiO₂ spacer) 12 between optical antennas 14 and an underlying metallic layer (e.g., Au) ground plane 16, shown disposed by way of example and not limitation over a substrate (e.g., Si). The maximum power transfer to the antenna is achieved in response to matching the metal loss resistance with the radiation resistance of the optical antenna. This matching is achieved in the present invention in response to properly selecting a thickness 20 for the dielectric layer.

FIG. 2 illustrates a circuit analogy for matching of antenna metal losses to the radiation resistance of the optical antenna. A source is shown providing power to a load comprising metal losses (R_{Metal}) 1 with radiation resistance (R_{Rad}) at a given wavelength.

Optimization of the dielectric thickness can be determined by simulation, empirical methods, or a combination of using simulation and empirical methods. In one preferred embodiment, finite difference time domain (FDTD) simulations are utilized to determine an optimum dielectric thickness.

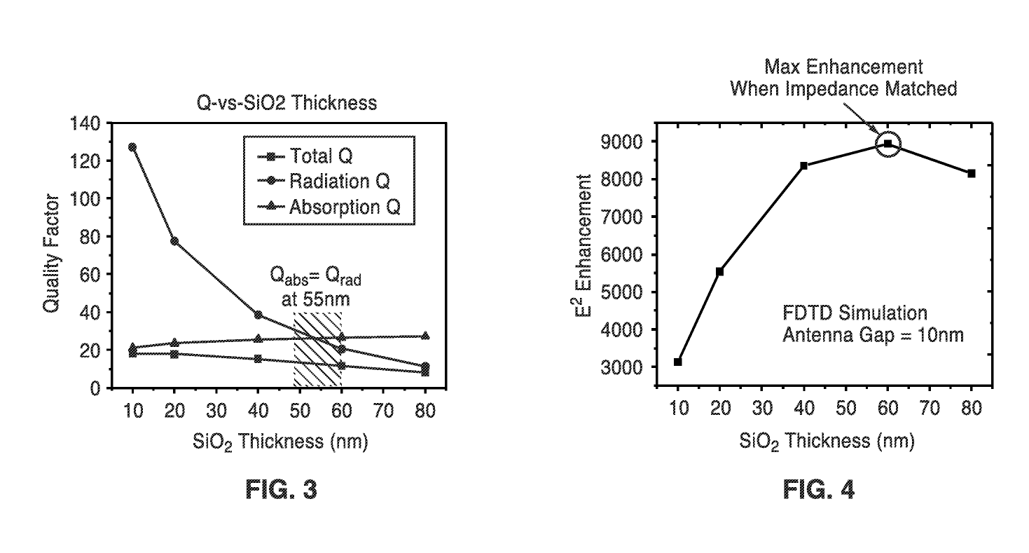

FIG. 3 depicts results from quality factor (Q) comparisons of different dielectric layer thicknesses for a given antenna operating wavelength, as determined in response to FDTD simulations showing total Q, radiation Q and absorption Q. It can be seen from the figure that radiation and absorption Q factors match when dielectric thickness is optimized at about 55 nm.

FIG. 4 depicts electric field enhancement with respect to different dielectric layer thicknesses for a given antenna geometry and operating wavelength. The simulated electric field intensity (E²) as a function of the dielectric spacer thickness confirms that the maximum field enhancement, shown in the graph reaching nearly 9000, is achieved at the impedance matching dielectric thickness as described in FIG. 3, which in this case was determined to be 55 nm.

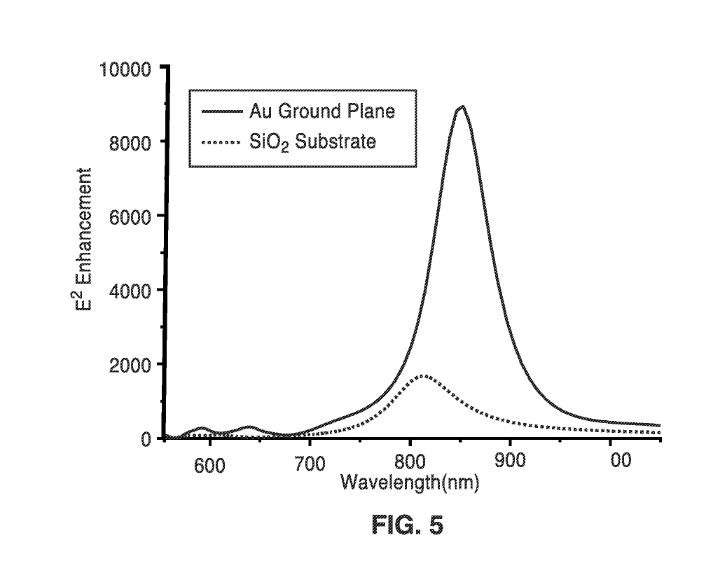

FIG. 5 is a graph comparing field intensity enhancement for antennas fabricated on the inventive ground plane as shown by the solid line, in comparison with antennas fabricated on a glass substrate as depicted by the dashed line. It can be seen from the figure that field intensity is enhanced by a factor of approximately five for antennas fabricated on the ground plane at the optical operating wavelength.

The inventive ground plane concept can be utilized in combination with bottom-up chemically synthesized nanoantennas (metallic nanoparticles) as well as top-down fabricated antenna structures (or combinations thereof).

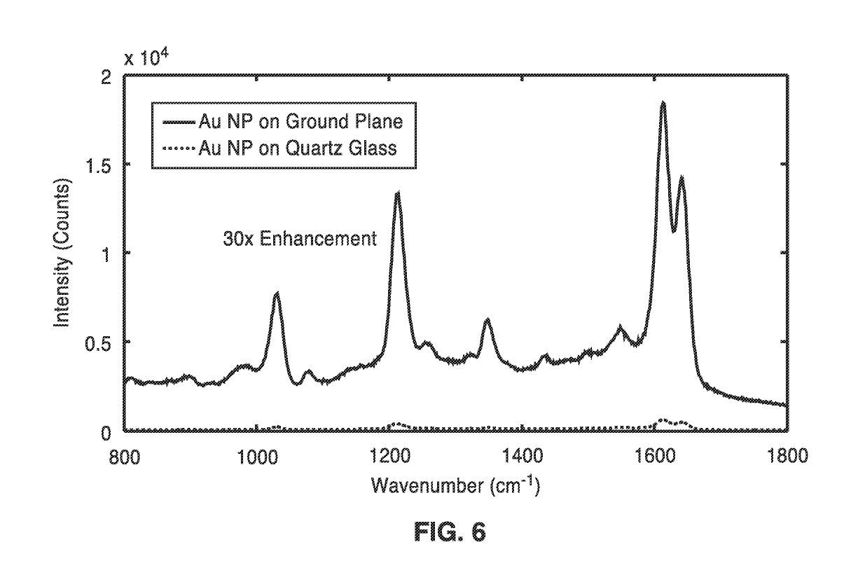

FIG. 6 is a graph of experimental data comparing surface-enhanced Raman spectroscopy (SERS) measurements for an optical antenna utilizing the inventive ground plane in comparison with the optical antenna fabricated on a quartz glass substrate. SERS for the inventive ground plane is shown in the solid line while an optical antenna structure on a quartz glass substrate is shown in the dashed lines. The dielectric layer in this experiment was fabricated from trans-1,2-bis (4-pyridyl)ethylene (BPE) molecule monolayer deposited on chemically synthesized nanoantennas (e.g., Au nanoparticles (NP)) arranged on a ground plane. As can be seen from the figure, the SERS signal generated by the inventive ground plane substrate is approximately thirty times (30×) stronger than the quartz glass surface. It should be appreciated that the inventive ground plane structure can also be utilized for enhancing other emission mechanisms such as fluorescence or photoluminescence.

From the discussion above it will be appreciated that the invention can be embodied in various ways, including the following:

1. An optical antenna ground plane apparatus, comprising: a metallic layer disposed as a ground plane proximal to an optical nanoantenna layer; and a dielectric spacer layer of a selected thickness disposed between said metallic layer and the optical nanoantenna layer; wherein the thickness of said dielectric spacer layer is determined in response to matching metal loss resistance and radiation resistance of the optical nanoantenna layer for a given optical antenna configuration and operating wavelength.

2. The apparatus of embodiment 1, wherein said dielectric spacer layer comprises SiO₂.

3. The apparatus of embodiment 1, wherein said metallic layer comprises Au.

4. The apparatus of embodiment 1, wherein metal loss resistance and radiation resistance of the optical nanoantenna layer for a given optical antenna configuration and operating wavelength is matched when radiation quality factor and absorption quality factor are equal.

5. The apparatus of embodiment 1, wherein said dielectric spacer thickness is determined in response to finite difference time domain (FDTD) simulations.

6. The apparatus of embodiment 1, wherein said optical nanoantenna ground plane apparatus enhances field intensity by multiple times over using a glass substrate as a ground plane.

7. The apparatus of embodiment 6, wherein said multiple times comprises five times.

8. The apparatus of embodiment 1, wherein said optical nanoantenna ground plane apparatus enhances surface-enhanced Raman spectroscopy (SERS) by more than an order of magnitude in comparison to optical antennas fabricated over a glass substrate.

9. The apparatus of embodiment 8, wherein said more than an order of magnitude comprises an increase by a factor of approximately thirty.

10. The apparatus of embodiment 1, wherein said dielectric comprises trans-1,2-bis ethylene (BPE) deposited on optical nanoantennas of the optical antenna layer.

11. An optical antenna ground plane apparatus, comprising: a metallic layer disposed as a ground plane proximal to an optical nanoantenna layer; and a dielectric spacer layer of a selected thickness disposed between said metallic layer and the optical nanoantenna layer; wherein the thickness of said dielectric spacer layer is determined in response to matching metal loss resistance and radiation resistance of the optical nanoantenna layer for a given optical nanoantenna configuration and operating wavelength; wherein metal loss resistance and radiation resistance of the optical nanoantenna layer for a given optical nanoantenna configuration and operating wavelength is matched when radiation quality factor and absorption quality factor are equal.

12. The apparatus of embodiment 11, wherein said dielectric spacer layer comprises SiO₂.

13. The apparatus of embodiment 11, wherein said metallic layer comprises Au.

14. The apparatus of embodiment 11, wherein said dielectric spacer thickness is determined in response to finite difference time domain (FDTD) simulations.

15. The apparatus of embodiment 11, wherein said optical nanoantenna ground plane apparatus enhances field intensity by multiple times over use of a glass substrate as a ground plane.

16. The apparatus of embodiment 15, wherein said field intensity is enhanced by a factor of approximately five.

17. The apparatus of embodiment 11, wherein said optical nanoantenna ground plane apparatus enhances surface-enhanced Raman spectroscopy (SERS) by more than an order of magnitude in comparison to optical nanoantennas fabricated over a glass substrate.

18. The apparatus of embodiment 17, wherein said surface-enhanced Raman spectroscopy (SERS) is enhanced by a factor of approximately thirty.

19. A method of fabricating an optical nanoantenna ground plane, comprising: determining a dielectric spacer layer thickness value at which metal loss resistance and radiation resistance are equal for an associated optical nanoantenna layer; fabricating a ground plane having a dielectric spacer layer, of said dielectric spacer layer thickness, disposed adjacent a nanoantenna layer, and a metallic ground plane layer.

20. A method as recited in embodiment 19, wherein metal loss resistance and radiation resistance of the optical nanoantenna layer for a given optical nanoantenna configuration and operating wavelength is considered matched when radiation quality factor and absorption quality factor are equal.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An optical antenna ground plane apparatus, comprising:
a metallic layer disposed as a ground plane proximal to an optical nanoantenna layer; and
a dielectric spacer layer of a selected thickness disposed between said metallic layer and the optical nanoantenna layer;
wherein the thickness of said dielectric spacer layer is determined in response to matching metal loss resistance and radiation resistance of the optical nanoantenna layer for a given optical antenna configuration and operating wavelength.

2. An apparatus as recited in claim 1, wherein said dielectric spacer layer comprises SiO₂.

3. An apparatus as recited in claim 1, wherein said metallic layer comprises Au.

4. An apparatus as recited in claim 1, wherein metal loss resistance and radiation resistance of the optical nanoantenna layer for a given optical antenna configuration and operating wavelength is matched when radiation quality factor and absorption quality factor are equal.

5. An apparatus as recited in claim 1, wherein said dielectric spacer thickness is determined in response to finite difference time domain (FDTD) simulations.

6. An apparatus as recited in claim 1, wherein said optical nanoantenna ground plane apparatus enhances field intensity by multiple times over using a glass substrate as a ground plane.

7. An apparatus as recited in claim 6, wherein said multiple times comprises five times.

8. An apparatus as recited in claim 1, wherein said optical nanoantenna ground plane apparatus enhances surface-enhanced Raman spectroscopy (SERS) by more than an order of magnitude in comparison to optical antennas fabricated over a glass substrate.

9. An apparatus as recited in claim 8, wherein said more than an order of magnitude comprises an increase by a factor of approximately thirty.

10. An apparatus as recited in claim 1, wherein said dielectric comprises trans-1,2-bis ethylene (BPE) deposited on optical nanoantennas of the optical antenna layer.

11. An optical antenna ground plane apparatus, comprising:
a metallic layer disposed as a ground plane proximal to an optical nanoantenna layer; and
a dielectric spacer layer of a selected thickness disposed between said metallic layer and the optical nanoantenna layer;
wherein the thickness of said dielectric spacer layer is determined in response to matching metal loss resistance and radiation resistance of the optical nanoantenna layer for a given optical nanoantenna configuration and operating wavelength;
wherein metal loss resistance and radiation resistance of the optical nanoantenna layer for a given optical nanoantenna configuration and operating wavelength is matched when radiation quality factor and absorption quality factor are equal.

12. An apparatus as recited in claim 11, wherein said dielectric spacer layer comprises SiO₂.

13. An apparatus as recited in claim 11, wherein said metallic layer comprises Au.

14. An apparatus as recited in claim 11, wherein said dielectric spacer thickness is determined in response to finite difference time domain (FDTD) simulations.

15. An apparatus as recited in claim 11, wherein said optical nanoantenna ground plane apparatus enhances field intensity by multiple times over use of a glass substrate as a ground plane.

16. An apparatus as recited in claim 15, wherein said field intensity is enhanced by a factor of approximately five.

17. An apparatus as recited in claim 11, wherein said optical nanoantenna ground plane apparatus enhances surface-enhanced Raman spectroscopy (SERS) by more than an order of magnitude in comparison to optical nanoantennas fabricated over a glass substrate.

18. An apparatus as recited in claim 17, wherein said surface-enhanced Raman spectroscopy (SERS) is enhanced by a factor of approximately thirty.

19. A method of fabricating an optical nanoantenna ground plane, comprising:
determining a dielectric spacer layer thickness value at which metal loss resistance and radiation resistance are equal for an associated optical nanoantenna layer;
fabricating a ground plane having a dielectric spacer layer, of said dielectric spacer layer thickness, disposed adjacent a nanoantenna layer, and a metallic ground plane layer.

20. A method as recited in claim 19, wherein metal loss resistance and radiation resistance of the optical nanoantenna layer for a given optical nanoantenna configuration and operating wavelength is considered matched when radiation quality factor and absorption quality factor are equal.
